(19) United States
(12) Patent Application Publication
(10) Pub. No.: US 2015/0151754 A1
(43) Pub. Date: Jun. 4, 2015

(54) ADAPTIVE CRUISE CONTROL SYSTEM FOR VEHICLE WITH MANUAL TRANSMISSION AND METHOD THEREFOR

(71) Applicant: MANDO CORPORATION, Pyeongtaek-si (KR)

(72) Inventor: Kwangjin HAN, Seongnam-si (KR)

(21) Appl. No.: 14/307,786

(22) Filed: Jun. 18, 2014

(30) Foreign Application Priority Data
Dec. 2, 2013 (KR) 10-2013-0148604

(51) Int. Cl. B60W 30/14; B60W 10/18; G01S 13/93; B60W 10/06; B60W 30/16; B60W 50/14

(52) U.S. Cl. CPC B60W 30/143; B60W 30/16; B60W 50/14; G01S 13/931; B60W 10/06; B60W 10/18; G01S 2013/9321; G01S 2013/9346; G01S 2013/935

(57) ABSTRACT

The present invention relates to an adaptive cruise control system for a vehicle with a manual transmission and a method therefor in which, when acceleration is achieved during adaptive cruise control in the vehicle of the manual transmission, a target gear step number is determined, and the determined target gear step number is displayed when the determined target gear step number and a current gear step number do not match. The present invention, provided is an adaptive cruise control system for a vehicle with a manual transmission, the system including a radar that generates an acceleration command or a deceleration command based on information of a leading vehicle and information of the own vehicle, a first sensing unit that senses a speed of the vehicle, a second sensing unit that senses an RPM of an engine, a third sensing unit that senses a position of the manual transmission.

### BACKGROUND

1. Field of the Invention

The present invention relates to an adaptive cruise control system for a vehicle with a manual transmission and a method therefor, and more specifically, to an adaptive cruise control system for a vehicle with a manual transmission and a method therefor in which, when acceleration is achieved during adaptive cruise control in a vehicle with a manual transmission, a target gear step number is determined, and the determined target gear step number is displayed when the determined target gear step number and a current gear step number do not match so that a vehicle driver can easily perform shift to the displayed target gear step number.

2. Discussion of Related Art

An adaptive cruise control system is mounted on a vehicle to provide convenience of a vehicle driver.

A number of adaptive cruise control systems such as those disclosed in Korean Patent Laid-Open Publication No. 2006-53652 and Korean Patent Laid-Open Publication No. 2008-32003 have been filed.

With the adaptive cruise control system, including the patents described above, for example, when a vehicle driver sets any desired running speed, such as 100 KPH, while a vehicle is running on an expressway or a driveway, an engine control apparatus automatically adjusts an amount of air and an amount of fuel so that the vehicle cruises at a constant speed set by the vehicle driver without the vehicle driver driving an accelerator pedal.

In a vehicle with an automatic transmission, an upward or downward shift occurs in a shift stage to control cruising.

However, in a vehicle with a manual transmission, running is controlled in a currently selected shift stage unless a vehicle driver performs shift. Thus, acceleration may be limited.

Therefore, there is a need for an adaptive cruise control system in which a vehicle driver is informed of a target gear step number and is enabled to perform shift to the target gear step number, such that the adaptive cruise control system can be implemented even in the vehicle with a manual transmission.

In other words, there is a need for an adaptive cruise control system that enables a manual transmission to perform a function of an automatic transmission instead during control of acceleration or deceleration while maintaining an appropriate speed relative to a leading vehicle.

### PRIOR ART DOCUMENTS

### Patent Document

[Patent Document 1] Korean Patent Laid-Open Publication No. 2006-53652 (May 22, 2006) titled “A Shift Control System When Cruise Control of Automatic Transmission On Vehicle And Method Thereof”

[Patent Document 2] Korean Patent Laid-Open Publication No. 2008-32003 (Apr. 11, 2008) titled “Vehicle Running Control Apparatus”

### SUMMARY OF THE INVENTION

The purpose of the present invention is to provide an adaptive cruise control system for a vehicle with a manual transmission and a method therefor in which, when acceleration is achieved during adaptive cruise control in a vehicle with a manual transmission, a target gear step number is determined, and the determined target gear step number is displayed when the determined target gear step number and a current gear step number do not match so that a vehicle driver can easily perform shift to the displayed target gear step number.

According to an embodiment of the present invention for achieving the above object, there is a provided an adaptive cruise control system for a vehicle with a manual transmission, the system including: a radar that generates an acceleration command or a deceleration command based on information of a leading vehicle and information of the own vehicle; a first sensing unit that senses a speed of the vehicle; a second sensing unit that senses an RPM of an engine; a third sensing unit that senses a position of the manual transmission; and a brake control apparatus that generates engine-required torque according to the acceleration command received from the radar during such control that the own vehicle runs while maintaining a set distance to the leading vehicle, transfers the engine-required torque to an engine control apparatus, determines a target gear step number using the speed of the vehicle sensed through the first sensing unit, the RPM of the engine sensed through the second sensing unit, and a gear step number corresponding to the position sensed through the third sensing unit when acceleration is achieved due to generation of the engine torque according to the engine-required torque in the engine control apparatus, and displays the determined target gear step number when the determined target gear step number and the gear step number corresponding to the position sensed through the third sensing unit do not match.

Further, the adaptive cruise control system for a vehicle with a manual transmission according to an embodiment of the present invention may further include a fourth sensing unit that senses an clutch input, wherein, when the clutch input is sensed from the fourth sensing unit, the brake control apparatus may generate an idle engine-required torque and transfer the idle engine-required torque to the engine control apparatus to maintain the RPM of the engine in a predetermined idle RPM state.

When the clutch input is not sensed through the fourth sensing unit, the brake control apparatus may generate engine-required torque to maintain a speed for each gear step number corresponding to the position sensed through the third sensing unit, and transfer the engine-required torque to the engine control apparatus.

The brake control apparatus may determine whether the clutch input is completed after transferring the idle required torque to the engine control apparatus, and provide notification information indicating that shift is completed if the gear step number corresponding to the sensed position of the transmission from the third sensing unit matches the target gear step number when it is determined that the clutch input is completed.

The brake control apparatus may determine whether the gear step number of the manual transmission and the determined target gear step number match, display the target gear step number or outputs shift notification sound when it is determined that the gear step numbers do not match, and generate engine-required torque to maintain a speed set for the target gear step number when it is determined that the gear step numbers match.

The brake control apparatus may further display a gear step number corresponding to the position sensed through the third sensing unit and a transmission manipulation direction from the gear step number to the target gear step number when displaying the target gear step number.

The brake control apparatus may generate brake-required torque according to the deceleration command received from the radar.

According to another embodiment of the present invention, there is a provided an adaptive cruise control system for a vehicle with a manual transmission, the system including: a radar that generates an acceleration command or a deceleration command based on information of a leading vehicle and information of the own vehicle; a first sensing unit that senses a speed of the vehicle; a second sensing unit that senses an RPM of an engine; a third sensing unit that senses a position of the manual transmission; an engine control apparatus that receives the acceleration command from the radar and generates engine-required torque according to the acceleration command; and a brake control apparatus that receives the deceleration command from the radar and generates brake-required torque according to the deceleration command, wherein the engine control apparatus determines a target gear step number using the speed of the vehicle sensed by the first sensing unit, the RPM of the engine sensed by the second sensing unit, and a gear step number corresponding to the position sensed by the third sensing unit when acceleration is achieved due to generation of engine torque according to the engine-required torque, and displays the determined target gear step number when the determined target gear step number and the gear step number corresponding to the position sensed by the third sensing unit do not match.

According to yet another embodiment of the present invention, there is a provided an adaptive cruise control method for a vehicle with a manual transmission, the method including steps of: receiving, by a brake control apparatus, an acceleration command or a deceleration command generated based on information of a leading vehicle and information of the own vehicle from a radar; generating, by the brake control apparatus, engine-required torque according to the acceleration command and transferring the engine-required torque to an engine control apparatus when the acceleration command is received in the receiving step; generating, by the engine control apparatus, engine torque according to the engine-required torque; determining, by the brake control apparatus, a target gear step number using a speed of the vehicle sensed by a first sensing unit, an RPM of an engine sensed by a second sensing unit, and a gear step number corresponding to a position sensed by a third sensing unit when acceleration according to the generated engine torque is achieved; determining, by the brake control apparatus, whether the determined target gear step number and the gear step number corresponding to the position sensed by the third sensing unit match; and displaying, by the brake control apparatus, the determined target gear step number when it is determined in the determining step that the gear step numbers do not match.

Further, the adaptive cruise control method for a vehicle with a manual transmission according to yet another embodiment of the present invention may further include: after the step of determining whether the gear step numbers match, generating, by the brake control apparatus, engine-required torque to maintain a speed set for the target gear step number when it is determined that the gear step numbers match in the step of determining whether the gear step numbers match.

Further, the adaptive cruise control method for a vehicle with a manual transmission according to yet another embodiment of the present invention may further include: after the displaying step, steps of: determining, by the brake control apparatus, whether a clutch input is sensed; and generating, by the brake control apparatus, an idle engine-required torque and transferring the idle engine-required torque to the engine control apparatus to maintain an RPM of the engine in a predetermined idle RPM state when it is determined in the determining step that the clutch input is sensed.

Further, the adaptive cruise control method for a vehicle with a manual transmission according to yet another embodiment of the present invention may further include: after the step of transferring the idle engine-required torque, steps of: determining, by the brake control apparatus, whether the clutch input is completed; receiving, by the brake control apparatus, the position of the manual transmission through the third sensing unit when it is determined in the determining step that the clutch input is completed; determining, by the brake control apparatus, whether a gear step number corresponding to the received position matches the target gear step number; and providing, by the brake control apparatus, notification information indicating that shift is completed when the gear step number corresponding to the received position matches the target gear step number.

Further, the adaptive cruise control method for a vehicle with a manual transmission according to yet another embodiment of the present invention may further include: after the step of providing notification information, causing, by the brake control apparatus, the displayed target gear step number to disappear.

Further, the adaptive cruise control method for a vehicle with a manual transmission according to yet another embodiment of the present invention may further include: after the displaying step, generating, by the brake control apparatus, engine-required torque to maintain a speed for each gear step number corresponding to the position sensed by the third sensing unit when the clutch input is not sensed.

Further, the adaptive cruise control method for a vehicle with a manual transmission according to yet another embodiment of the present invention may further include: after the receiving step, generating, by the brake control apparatus, brake-required torque according to the deceleration command received from the radar.

Further, according to yet another embodiment of the present invention, there is provided an adaptive cruise control method for a vehicle with a manual transmission, the method including: receiving, by a brake control apparatus, a deceleration command generated based on information of a leading vehicle and information of the own vehicle from a radar; receiving, by an engine control apparatus, a generated acceleration command from the radar; generating, by the engine control apparatus, engine-required torque according to the acceleration command; determining, by the engine control apparatus, a target gear step number using a speed of the vehicle sensed by a first sensing unit, an RPM of an engine sensed by a second sensing unit, and a gear step number corresponding to a position sensed by a third sensing unit when acceleration is achieved due to generation of engine torque according to the engine-required torque; determining, by the engine control apparatus, whether the determined target gear step number and the gear step number corresponding to the position sensed by the third sensing unit match; and displaying, by the engine control apparatus, the determined target gear step number when it is determined in the determining step that the gear step numbers do not match.

Further, the adaptive cruise control method for a vehicle with a manual transmission according to yet another embodiment of the present invention may further include: after the step of receiving the deceleration command, generating, by the brake control apparatus, brake-required torque according to the deceleration command received from the radar.

### Effects of the Invention

According to the embodiment of the present invention, in a vehicle with a manual transmission, when acceleration is achieved during adaptive cruise control, the target gear step number is determined, and the determined target gear step number is displayed when the determined target gear step number and a current gear step number do not match, so that the vehicle driver can easily perform shift to the displayed target gear step number. Accordingly, the adaptive cruise control is possible even in the vehicle with a manual transmission, thus reducing fuel consumption while maximizing motion efficiency.

Further, according to the embodiment of the present invention, when the shift to the target gear step number is completed, a need of the shift disappears so that the vehicle driver can easily recognize that the shift to the target gear step number is achieved.

Furthermore, according to the embodiment of the present invention, the transmission manipulation direction can be intuitively recognized by displaying the current gear step number and the transmission manipulation direction to the target gear step number together.

### BRIEF DESCRIPTION OF THE DRAWINGS

FIG. 1 is a block diagram illustrating an adaptive cruise control system for a vehicle with a manual transmission according to an embodiment of the present invention;

FIG. 2 is a block diagram illustrating a brake control apparatus illustrated in FIG. 1;

FIG. 3 is an operation flowchart illustrating an adaptive cruise control method for a vehicle with a manual transmission according to an embodiment of the present invention;

FIG. 4 is a graph showing shift start and shift end for shift to a target gear step number after the target gear step number is displayed according to a vehicle speed, an RPM and a clutch; and

FIG. 5 is a diagram illustrating a screen in which a current gear step number and a target gear step number are displayed.

### DETAILED DESCRIPTION OF EXEMPLARY EMBODIMENTS

Hereinafter, preferred embodiments of the present invention will be described in detail with reference to the accompanying drawings.

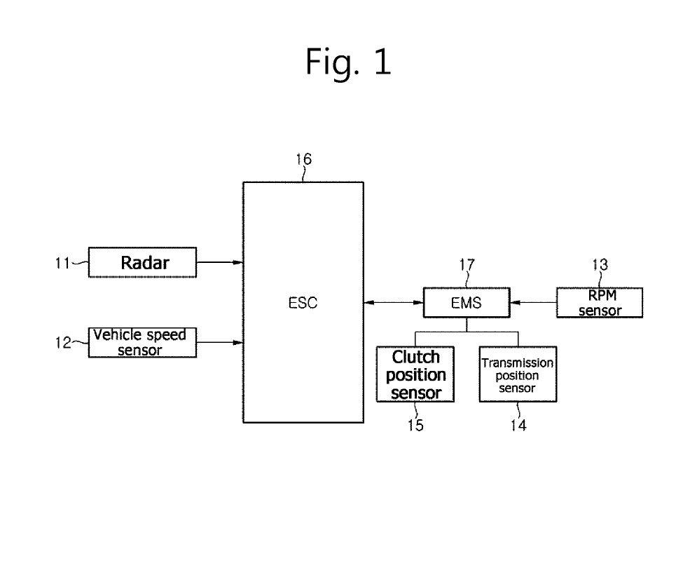

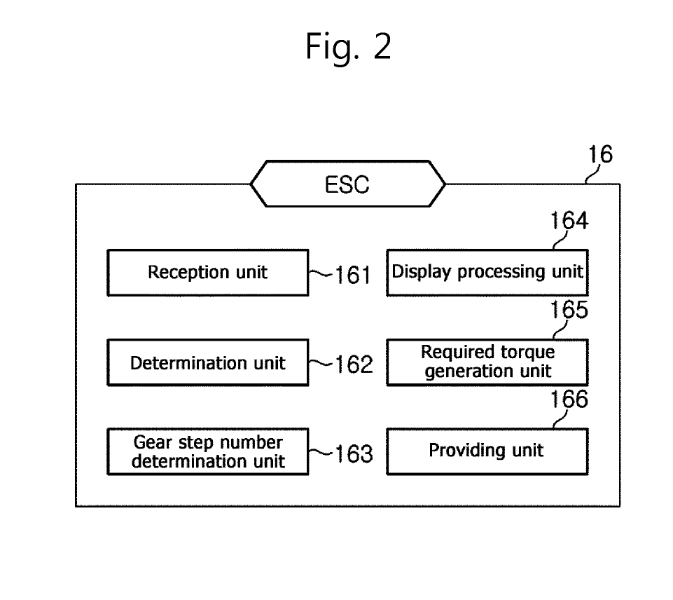

FIG. 1 is a block diagram illustrating an adaptive cruise control system for a vehicle with a manual transmission according to an embodiment of the present invention, and FIG. 2 is a block diagram illustrating a brake control apparatus illustrated in FIG. 1.

Referring to FIG. 1, an adaptive cruise control system for a vehicle with a manual transmission according to an embodiment of the present invention includes a radar 11, first to fourth sensing units 12, 13, 14 and 15, a brake control apparatus 16, and an engine control apparatus 17.

The radar 11 measures information of a leading vehicle and information of the own car. Further, the radar 11 generates an acceleration command or a deceleration command based on the information of the leading vehicle and the information of the own car, and provides the generated acceleration command or deceleration command to the brake control apparatus 16.

The first sensing unit 12 is a vehicle speed sensor that senses a speed of the vehicle. The first sensing unit 12 senses a speed of the running vehicle to deliver the speed to the brake control apparatus 16, or delivers a speed of the vehicle calculated by the radar 11 to the brake control apparatus 16.

The second sensing unit 13 is an RPM sensor for sensing an RPM of an engine. The RPM of the engine measured by the RPM sensor is delivered to the brake control apparatus 16 via the engine control apparatus 17.

The third sensing unit 14 is a transmission position sensor for sensing a current gear step number, and delivers the sensed current gear step number to the brake control apparatus 16 via the engine control apparatus 17.

The fourth sensing unit 15 is a clutch position sensor for sensing whether there is an input of a clutch, and transfers information indicating presence/absence of the clutch input to the engine control apparatus 17. The engine control apparatus 17 transfers the information indicating presence/absence of the clutch input to the brake control apparatus 16.

While the case in which the sensing results are generally collected in the brake control apparatus 16 has been described, the present invention is not necessarily limited thereto, and a configuration in which the brake control apparatus 16 transfers an acceleration command to the engine control apparatus 17 and then the engine control apparatus 17 generally collects sensing results from the first to fourth sensing units 12, 13, 14 and 15 may be implemented.

The brake control apparatus 16 is an electronic stability control (ESC; vehicle posture stabilization system), and receives the acceleration command or the deceleration command generated from the radar 11.

The brake control apparatus 16 may perform deceleration control according to the deceleration command when the command received from the radar 11 is the deceleration command or may transfer the acceleration command or engine-required torque generated according to the acceleration command to the engine control apparatus 17 when the command received from the radar 11 is the acceleration command.

The engine control apparatus 17 is an engine management system (EMS) and controls the engine, which converts combustion energy generated due to combustion of a fuel into kinetic energy.

When acceleration is achieved due to the generation of the engine-required torque according to the acceleration command, the brake control apparatus 16 determines a target gear step number based on the speed of the vehicle, the RPM of the engine, and the current gear step number sensed through the first, second and third sensing units 12, 13 and 14, and displays the target gear step number when the determined target gear step number and the current gear step number do not match. In this case, the current gear step number and the target gear step number are displayed together on a screen, and a manipulation direction from the current gear step number to the target gear step number is displayed, such that a vehicle driver can easily perform shift to the target gear step number. Also, the transmission manipulation direction may be indicated by an arrow or may be indicated by a solid line to be distinguished from other lines.

When the acceleration according to the engine-required torque is achieved, the target gear step number is displayed if the current gear step number and the target gear step number do not match to cause the vehicle driver to perform shift, so that the adaptive cruise control system, in which acceleration and deceleration control is performed while an appropriate speed is maintained relative to the leading vehicle, can be implemented even in the vehicle with a manual transmission.

The brake control apparatus 16 determines whether the clutch input is sensed through the fourth sensing unit 15 after the target gear step number is displayed. When the clutch input is sensed, the brake control apparatus 16 generates an idle engine-required torque to maintain the RPM of the engine in a predetermined idle RPM state and transfers the idle engine-required torque to the engine control apparatus 17. When the clutch input is not sensed, the brake control apparatus 16 generates an engine-required torque to maintain an appropriate speed set according to the current gear step number and transfers the engine-required torque to the engine control apparatus 17. While the case in which the brake control apparatus 16 generates the idle engine-required torque has been described herein, the engine control apparatus 17 may generate the idle engine-required torque.

Further, after the clutch input is sensed, the brake control apparatus 16 determines whether the gear step number corresponding to the position sensed through the third sensing unit 14 matches the target gear step number, and outputs notification information indicating that shift is completed when the gear step numbers match. In this case, the target gear step number is displayed while shift to the target gear step number is waiting. On the other hand, when the shift to the target gear step number is completed, the target gear step number displayed on the screen is caused to disappear, so that the vehicle driver can easily recognize that the shift to the target gear step number is completed.

Referring to FIG. 2, the brake control apparatus 16 includes a reception unit 161, a determination unit 162, a gear step number determination unit 163, a display processing unit 164, a required torque generation unit 165, and a providing unit 166. The reception unit 161, the determination unit 162, the gear step number determination unit 163, the display processing unit 164, the required torque generation unit 165 and the providing unit 166 may be components of the engine control apparatus 17 rather than the brake control apparatus 16. A case in which such components are components of the brake control apparatus 16 is described herein. However, a configuration in which such components are components of the engine control apparatus 17, and the engine control apparatus 17 determines the target gear step number to display the target gear step number to the vehicle driver when there is a need of shift may be implemented.

Hereinafter, a repeated description is omitted and a different configuration will be mainly described.

The reception unit 161 receives the acceleration command or the deceleration command from the radar 11. Further, the reception unit 161 receives the sensing results from the first to fourth sensing units 12, 13, 14 and 15 described above. In this case, the reception unit 161 may receive the sensing results from the second to fourth sensing units 13, 14 and 15 via the engine control apparatus 17.

A reception unit of the engine control apparatus 17 receives only the acceleration command, and the reception unit of the brake control apparatus 16 receives the deceleration command. Therefore, the engine control apparatus 17 does not determine whether the command is the accelerating command or the deceleration command.

The determination unit 162 determines whether the command received by the reception unit 161 is the acceleration command or the deceleration command. In this case, identification information for identifying the acceleration command and the deceleration command may be included in the acceleration command and the deceleration command, so that it can be determined whether the command is the accelerating command or the deceleration command based on the identification information.

After the acceleration is achieved due to the engine-required torque according to the acceleration command, the gear step number determination unit 163 determines the target gear step number based on the speed of the vehicle, the engine RPM and the current gear step number sensed through the first to third sensing units 12, 13 and 14.

The determination unit 162 determines whether the current gear step number of the manual transmission received from the third sensing unit 13, that is, the transmission position sensor and the target gear step number determined by the gear step number determination unit 163 match.

When it is determined in the determination unit 162 that the current gear step number and the target gear step number do not match, the display processing unit 164 displays the target gear step number determined by the gear step number determination unit 163 on a display device (not illustrated). It is preferable that the manipulation direction from the current gear step number to the target gear step number is displayed together. Further, the target gear step number is displayed using a method such as blinking, enlarging, circle characters, or a combination thereof so that the vehicle driver is informed of the target gear step number. Further, the current gear step number is displayed to be intuitively recognizable. The target gear step number is displayed in an enlarged from in comparison with the current gear step number, so that the vehicle driver can be aware of a current state, and perform shift to the target gear step number.

Further, when the shift to the target gear step number is completed, the display processing unit 164 causes the need of the shift to disappear and displays the current gear step number after the shift.

The required torque generation unit 165 generates the engine-required torque according to the acceleration command. After the target gear step number is displayed, the required torque generation unit 165 also generates idle engine-required torque to maintain an idle RPM request state when the clutch input is sensed or generates engine-required torque to maintain an appropriate speed for each current gear step number when the clutch input is not sensed.

The providing unit 166 provides the engine-required torque generated by the required torque generation unit 165 to the engine control apparatus 17. In this case, the engine control apparatus 17 generates engine torque according to the generated engine-required torque to control the output of the engine.

An adaptive cruise control method for a vehicle with a manual transmission having such a configuration will be described.

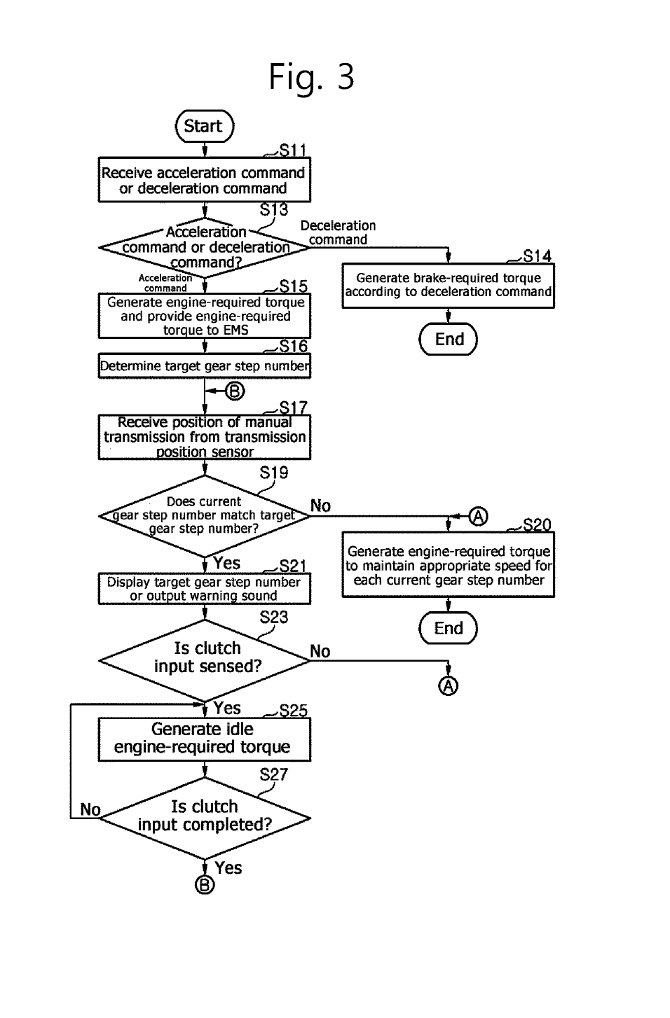

FIG. 3 illustrates an operation flowchart illustrating the adaptive cruise control method for a vehicle with a manual transmission according to an embodiment of the present invention.

FIG. 3 is an operation flowchart in which the brake control apparatus 16 receives the deceleration command or the acceleration command from the radar 11 and determines a target gear step number when acceleration according to engine torque is achieved. Although not illustrated in drawings, a configuration in which the engine control apparatus 17 receives the acceleration command from the radar 11, the brake control apparatus 16 receives the deceleration command from the radar 11, and the engine control apparatus 17 determines the target gear step number when the acceleration according to the engine torque is achieved may be implemented.

In other words, the adaptive cruise control method for a vehicle with a manual transmission according to an embodiment of the present invention may be implemented in a first embodiment in which the brake control apparatus 16 receives both the acceleration command and the deceleration command from the radar 11, and a second embodiment in which the brake control apparatus 16 receives the deceleration command and the engine control apparatus 17 receives the acceleration command. Hereinafter, an operation of the brake control apparatus 16 will be mainly described.

Referring to FIG. 3, the brake control apparatus 16 receives the acceleration command or the deceleration command from the radar 11 during adaptive cruise control (S11).

The brake control apparatus 16 determines whether the command received from the radar 11 is the acceleration command or the deceleration command (S13).

When it is determined in step (S13) that the command received from the radar 11 is the deceleration command, the brake control apparatus 16 generates brake-required torque according to the received deceleration command such that deceleration control is performed (S14).

When it is determined in step (S13) that the command received from the radar 11 is the acceleration command, the brake control apparatus 16 generates the engine-required torque according to the received acceleration command and transfers the engine-required torque to the engine control apparatus (EMS) 17 (S15). The engine control apparatus 17 generates engine torque according to the generated engine-required torque and controls the output of the engine so that the acceleration is achieved.

The brake control apparatus 16 receives the speed of the vehicle accelerated according to the acceleration command, the engine RPM, and the current gear step number through the first, second and third sensing units 12, 13 and 14, and determines the target gear step number based on the speed of the vehicle, the engine RPM, and the current gear step number (S16). The determination of the target gear step number is necessary to implement an adaptive cruise control system in a vehicle with a manual transmission rather than an automatic transmission.

The brake control apparatus 16 then receives a position of the manual transmission from the third sensing unit 13, that is, the transmission position sensor (S17).

The brake control apparatus 16 compares the current gear step number received through the third sensing unit 14 with the target gear step number determined in step S16 described above, and determines whether the gear step numbers match (S19). In this case, when the current gear step number and the target gear step number do not match and the shift is necessary, notification sound indicating a need of the shift may be output through a speaker or the target gear step number is displayed on a screen, so that the need of the shift can be recognized by the vehicle driver. A case in which the shift is necessary may correspond to a case in which the speed of the vehicle maintains an appropriate speed for each current gear step number for a predetermined time in a state in which the acceleration according to the engine-required torque is achieved.

When it is determined in step S19 that the current gear step number and the target gear step number match, the brake control apparatus 16 generates the engine-required torque to maintain an appropriate speed set according to the current gear step number (S20). In this case, the brake control apparatus 16 may further include a memory (not illustrated) that stores the appropriate speed for each gear step number.

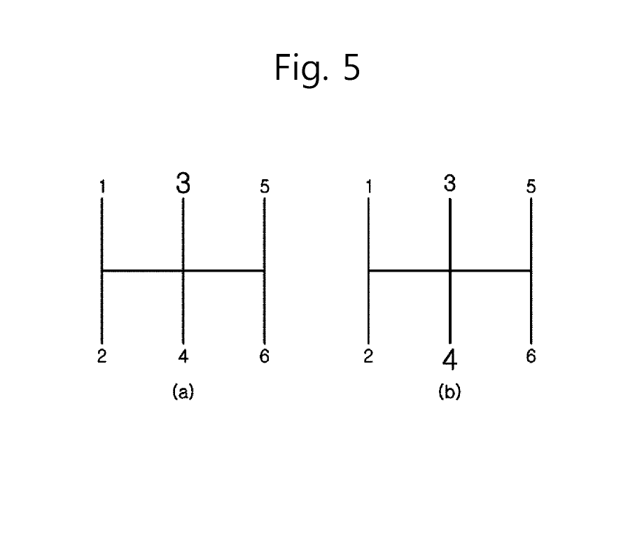

When it is determined in step S19 that the current gear step number and the target gear step number do not match, the brake control apparatus 16 displays the target gear step number determined in step S16 described above or outputs warning sound, such as shift notification sound (S21). In this case, both the current gear step number and the target gear step number are displayed as illustrated in (b) of FIG. 5. The target gear step number may be displayed to be larger than the current gear step number, and the transmission manipulation direction may be displayed on a screen of a display device included in the vehicle. (a) of FIG. 5 illustrates a display form of the current gear step number, but the present invention is not necessarily limited thereto. When the current gear step number is displayed on the screen, the display form may be determined to be lighting/blinking, different upward/downward shift colors, or the like.

The brake control apparatus 16 then determines whether the clutch input is sensed (S23).

When it is determined in step S23 that the clutch input is not sensed, the brake control apparatus 16 proceeds to step S20 described above to generate required torque so that an appropriate speed corresponding to the current gear step number is maintained.

When it is determined in step S23 that the clutch input is sensed, the brake control apparatus 16 generates the idle engine-required torque to maintain an idle RPM state (S25). In this case, the idle RPM state is a state in which the engine RPM is equal to or more than a minimum idle required RPM and equal to or less than an excessively required RPM. The engine-required torque is generated to control acceleration and deceleration of the vehicle so that an appropriate speed area for each gear step number is maintained and the idle RPM state is maintained.

The brake control apparatus 16 then determines whether the clutch input is completed (S27). In other words, the brake control apparatus 16 determines that the clutch input is completed when information indicating no clutch input is received from the fourth sensing unit 15.

When it is determined in step S27 that the clutch input is not completed, that is, that information indicating the clutch input is received from the fourth sensing unit 15, the brake control apparatus 16 proceeds to step S25 described above and generates the idle engine-required torque.

When it is determined in step S27 that the clutch input is completed, in other words, when information indicating no clutch input is received from the fourth sensing unit 15, the brake control apparatus 16 proceeds to step S17 described above in which the brake control apparatus 16 receives the position of the manual transmission from the third sensing unit 14, that is, the transmission position sensor, determines whether the current gear step number corresponding to the received position matches the target gear step number determined in step S16 described above, and provides the notification information indicating that the shift to the target gear step number is completed.

While the brake control apparatus 16 determines the target gear step number after the acceleration is achieved during the adaptive cruise control, and displays the target gear step number when the target gear step number and the current gear step number do not match has been described, in another embodiment, the brake control apparatus 16 receives the deceleration command, and the engine control apparatus 17 receive the acceleration command, generates engine-required torque according to the acceleration command, generates the engine torque according to the generated engine-required torque, and displays the target gear step number determined using the speed of the vehicle, the RPM of the engine, and the gear step number corresponding to the position of the manual transmission sensed by the first to third sensing unit described above after the acceleration is achieved. Further, the engine control apparatus 17 compares the target gear step number with the current gear step number based on the position of the manual transmission sensed through the third sensing unit 14, and displays the target gear step number or output shift notification sound when the gear steps numbers do not match, so that a vehicle driver can easily recognize that the shift is necessary. Further, after the target gear step number is displayed, the engine control apparatus 17 generates an idle engine-required torque to maintain a predetermined idle RPM state when the clutch input is sensed or generates the engine-required torque to maintain a speed for each gear step number corresponding to the position sensed through the third sensing unit 14 when the clutch input is not sensed.

The radar 11 is installed in a vehicle having a manual transmission, and the brake control apparatus 16 or the engine control apparatus 17 displays the target gear step number when the shift is necessary to maintain an appropriate distance from the leading vehicle through the installed radar 11, so that the vehicle driver can perform the shift. Accordingly, the adaptive cruise control system is also applicable to the vehicle with a manual transmission, so that vehicle models to which the adaptive cruise control system is to be applied can be expanded.

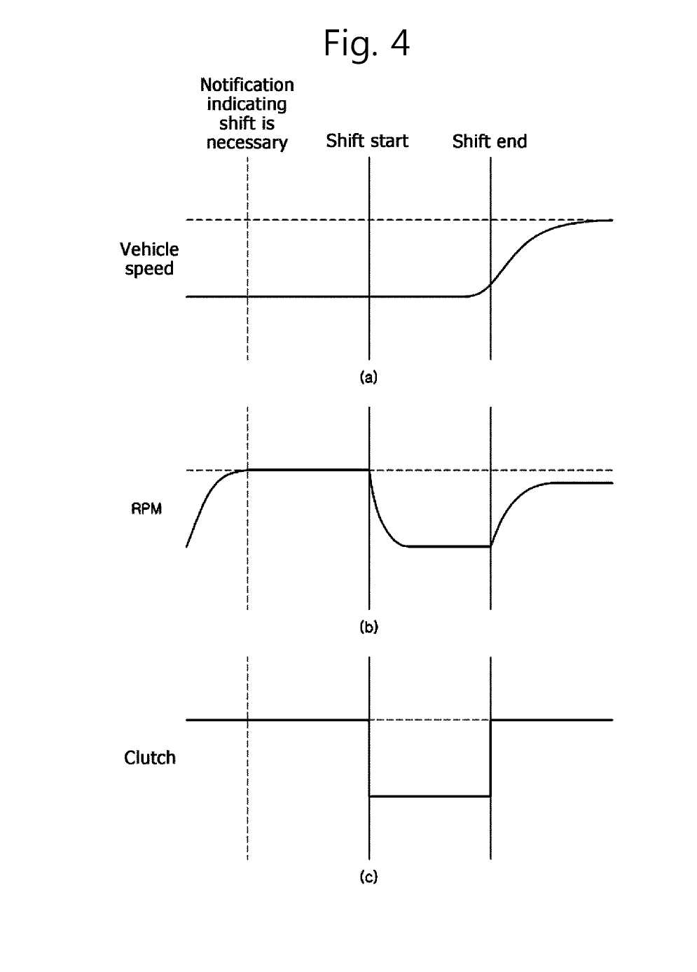

FIG. 4 is a graph showing a change in the vehicle speed, the RPM and the clutch when a need of the shift is informed during adaptive cruise control, the shift starts, and the shift ends. This graph shows, for example, a case in which the gear step number is changed to step 4 when the current gear step number is step 3. An appropriate speed for each gear step number is applied when downward shift rather than upward shift is performed. The upward shift will be described by way of example herein.

As illustrated in (a) of FIG. 4, it can be seen that a vehicle speed, which is a speed of the vehicle, is changed to maintain an appropriate speed of the gear step number corresponding to step 3 after necessary shift starts and before the shift ends, and to maintain an appropriate speed of the gear step number corresponding to step 4 after the shift ends.

(b) of FIG. 4 is a graph showing an RPM of the engine. An idle RPM state is maintained from shift start to shift end. In other words, after the notification of the shift, an excessive RPM or less of the current gear step number is maintained until the clutch input is sensed, an idle RPM state is maintained until the shift to the target gear step number, that is, step 4 is performed after the clutch input is sensed, and the excessive RPM or less of the target gear step number is maintained after the shift to the target gear step number is completed, as illustrated in (c) of FIG. 4.

The present invention is not limited to the embodiments described above, and various variations and modifications may be made by those skilled in the art, and are included in the spirit and scope of the present invention defined in the accompanying claims.

Description of Reference Numerals

| | |
|---|---|
| 11: Radar | 12: Vehicle speed sensor |
| 13: RPM sensor | 14: Transmission position sensor |
| 15: Clutch position sensor | 16: ESC |
| 17: EMS | 161: Reception unit |
| 162: Determination unit | 163: Gear step number determination unit |
| 164: Display processing unit | 165: Required torque generation unit |
| 166: Providing unit | |

What is claimed is:

1. An adaptive cruise control system for a vehicle with a manual transmission, the system comprising:
a radar that generates an acceleration command or a deceleration command based on information of a leading vehicle and information of the own vehicle;
a first sensing unit that senses a speed of the vehicle;
a second sensing unit that senses an RPM of an engine;
a third sensing unit that senses a position of the manual transmission; and
a brake control apparatus that generates engine-required torque according to the acceleration command received from the radar during such control that the own vehicle runs while maintaining a set distance to the leading vehicle, transfers the engine-required torque to an engine control apparatus, determines a target gear step number using the speed of the vehicle sensed through the first sensing unit, the RPM of the engine sensed through the second sensing unit, and a gear step number corresponding to the position sensed through the third sensing unit when acceleration is achieved due to generation of the engine torque according to the engine-required torque in the engine control apparatus, and displays the determined target gear step number when the determined target gear step number and the gear step number corresponding to the position sensed through the third sensing unit do not match.

2. The adaptive cruise control system according to claim 1, further comprising a fourth sensing unit that senses an clutch input,
wherein, when the clutch input is sensed from the fourth sensing unit, the brake control apparatus generates an idle engine-required torque and transfers the idle engine-required torque to the engine control apparatus to maintain the RPM of the engine in a predetermined idle RPM state.

3. The adaptive cruise control system according to claim 2, wherein: when the clutch input is not sensed through the fourth sensing unit, the brake control apparatus generates engine-required torque to maintain a speed for each gear step number corresponding to the position sensed through the third sensing unit, and transfers the engine-required torque to the engine control apparatus.

4. The adaptive cruise control system according to claim 2, wherein the brake control apparatus determines whether the clutch input is completed after transferring the idle required torque to the engine control apparatus, and provides notification information indicating that shift is completed if the gear step number corresponding to the sensed position of the transmission from the third sensing unit matches the target gear step number when it is determined that the clutch input is completed.

5. The adaptive cruise control system according to claim 1, wherein the brake control apparatus determines whether the gear step number of the manual transmission and the determined target gear step number match, displays the target gear step number or outputs shift notification sound when it is determined that the gear step numbers do not match, and generates engine-required torque to maintain a speed set for the target gear step number when it is determined that the gear step numbers match.

6. The adaptive cruise control system according to claim 1, wherein the brake control apparatus further displays a gear step number corresponding to the position sensed through the third sensing unit and a transmission manipulation direction from the gear step number to the target gear step number when displaying the target gear step number.

7. The adaptive cruise control system according to claim 1, wherein the brake control apparatus generates brake-required torque according to the deceleration command received from the radar.

8. An adaptive cruise control system for a vehicle with a manual transmission, the system comprising:
a radar that generates an acceleration command or a deceleration command based on information of a leading vehicle and information of the own vehicle;
a first sensing unit that senses a speed of the vehicle;
a second sensing unit that senses an RPM of an engine;
a third sensing unit that senses a position of the manual transmission;
an engine control apparatus that receives the acceleration command from the radar and generates engine-required torque according to the acceleration command; and
a brake control apparatus that receives the deceleration command from the radar and generates brake-required torque according to the deceleration command,
wherein the engine control apparatus determines a target gear step number using the speed of the vehicle sensed by the first sensing unit, the RPM of the engine sensed by the second sensing unit, and a gear step number corresponding to the position sensed by the third sensing unit when acceleration is achieved due to generation of engine torque according to the engine-required torque, and displays the determined target gear step number when the determined target gear step number and the gear step number corresponding to the position sensed by the third sensing unit do not match.

9. An adaptive cruise control method for a vehicle with a manual transmission, the method comprising steps of:
receiving, by a brake control apparatus, an acceleration command or a deceleration command generated based on information of a leading vehicle and information of the own vehicle from a radar;
generating, by the brake control apparatus, engine-required torque according to the acceleration command and transferring the engine-required torque to an engine control apparatus when the acceleration command is received in the receiving step;
generating, by the engine control apparatus, engine torque according to the engine-required torque;
determining, by the brake control apparatus, a target gear step number using a speed of the vehicle sensed by a first sensing unit, an RPM of an engine sensed by a second sensing unit, and a gear step number corresponding to a position sensed by a third sensing unit when acceleration according to the generated engine torque is achieved;
determining, by the brake control apparatus, whether the determined target gear step number and the gear step number corresponding to the position sensed by the third sensing unit match; and
displaying, by the brake control apparatus, the determined target gear step number when it is determined in the determining step that the gear step numbers do not match.

10. The adaptive cruise control method according to claim 9, further comprising: after the step of determining whether the gear step numbers match,
generating, by the brake control apparatus, engine-required torque to maintain a speed set for the target gear step number when it is determined that the gear step numbers match in the step of determining whether the gear step numbers match.

11. The adaptive cruise control method according to claim 9, further comprising: after the displaying step, steps of:
determining, by the brake control apparatus, whether a clutch input is sensed; and
generating, by the brake control apparatus, an idle engine-required torque and transferring the idle engine-required torque to the engine control apparatus to maintain an RPM of the engine in a predetermined idle RPM state when it is determined in the determining step that the clutch input is sensed.

12. The adaptive cruise control method according to claim 11, further comprising: after the step of transferring the idle engine-required torque, steps of:
determining, by the brake control apparatus, whether the clutch input is completed;
receiving, by the brake control apparatus, the position of the manual transmission through the third sensing unit when it is determined in the determining step that the clutch input is completed;
determining, by the brake control apparatus, whether a gear step number corresponding to the received position matches the target gear step number; and
providing, by the brake control apparatus, notification information indicating that shift is completed when the gear step number corresponding to the received position matches the target gear step number.

13. The adaptive cruise control method according to claim 12, further comprising: after the step of providing notification information, causing, by the brake control apparatus, the displayed target gear step number to disappear.

14. The adaptive cruise control method according to claim 11, further comprising: after the displaying step,
generating, by the brake control apparatus, engine-required torque to maintain a speed for each gear step number corresponding to the position sensed by the third sensing unit when the clutch input is not sensed.

15. The adaptive cruise control method according to claim 9, further comprising: after the receiving step,
generating, by the brake control apparatus, brake-required torque according to the deceleration command received from the radar.

16. An adaptive cruise control method for a vehicle with a manual transmission, the method comprising:
receiving, by a brake control apparatus, a deceleration command generated based on information of a leading vehicle and information of the own vehicle from a radar;
receiving, by an engine control apparatus, a generated acceleration command from the radar;
generating, by the engine control apparatus, engine-required torque according to the acceleration command;
determining, by the engine control apparatus, a target gear step number using a speed of the vehicle sensed by a first sensing unit, an RPM of an engine sensed by a second sensing unit, and a gear step number corresponding to a position sensed by a third sensing unit when acceleration is achieved due to generation of engine torque according to the engine-required torque;
determining, by the engine control apparatus, whether the determined target gear step number and the gear step number corresponding to the position sensed by the third sensing unit match; and
displaying, by the engine control apparatus, the determined target gear step number when it is determined in the determining step that the gear step numbers do not match.

17. The adaptive cruise control method according to claim 16, further comprising: after the step of receiving the deceleration command,
generating, by the brake control apparatus, brake-required torque according to the deceleration command received from the radar.
